(19) United States
(12) Patent Application Publication
(10) Pub. No.: US 2018/0353812 A1
(43) Pub. Date: Dec. 13, 2018

(54) Data Driven System For Providing Customized Exercise Plans

(71) Applicants: Michael G. Lannon, Orleans, MA (US); Joshua J. Roman, Scituate, MA (US); David M. Alexander, Norwell, MA (US); Eric Tobia, Cohasset, MA (US)

(72) Inventors: Michael G. Lannon, Orleans, MA (US); Joshua J. Roman, Scituate, MA (US); David M. Alexander, Norwell, MA (US); Eric Tobia, Cohasset, MA (US)

(73) Assignee: Michael G. Lannon, Rockland, MA (US)

(21) Appl. No.: 15/657,264

(22) Filed: Jul. 24, 2017

Related U.S. Application Data
(60) Provisional application No. 62/516,198, filed on Jun. 7, 2017.

(51) Int. Cl. A63B 24/00; G06F 19/00

(52) U.S. Cl. CPC A63B 24/0075; A63B 24/0087; G06F 19/3481; A63B 24/0062

(57) ABSTRACT

Techniques for configuring an exercise machine to operate according to a predefined workout regimen are described. The exercise machine includes exercise apparatus portion that is controlled and configured at least in part by a computing system portion. The computing system receives an operator selection of a selected predefined workout regimen, and operator data including at least operator gender, operator height and operator age and the computing system retrieves parameter data to configure an exercise instruction that is part of the selected workout regimen. The parameter data is retrieved from a database that stores at least range of motion data and maximum weight data searchable by a cohort, e.g., gender/height cohorts or gender/age cohorts and converts the retrieved parameter data into settings data to configure corresponding portions of the exercise apparatus according to the configured exercise instruction.

### CLAIM OF PRIORITY

This application claims priority under 35 U.S.C. § 119(e) to provisional U.S. Patent Application 62/516,198, filed on Jun. 7, 2017, entitled: “Data Driven System for Providing Customized Exercise Plans”, the entire contents of which are hereby incorporated by reference.

### BACKGROUND

This disclosure relates to exercise and exercise equipment.

Regular exercise and physical activity are important and beneficial for long-term health. Various types of exercise equipment are known. Some types of equipment are relatively simple to use. For example, there exists types of treadmills where settings such as speed, incline and time are configurable for proper use of the treadmills. Other types of exercise equipment are more complex to properly use. For example, certain types of strength training machines require configuration of settings such as load, repetitions, rates of repetitions and time, but also require adjustment of an operator's position, seat height, and the use of different mechanisms during operation such as those for legs and arms. With both of these types of equipment there is a need for the operator to remember required settings for the equipment and have an understanding of when these settings should be changed.

Several approaches have been developed to simplify operation of such exercise equipment. Such approaches include producing customized instruction programs that are based on an operator's prior exercise performance. Such approaches have minimized the need for extensive instruction from a personal trainer or instructor and are capable of recording the progress of the operator and thus customizing workouts for each specific operator. These approaches have been extended to both cardio type equipment and strength type of equipment. As a result, these approaches have minimized the need for the operator to remember required settings for the equipment and have an understanding of when these settings should be changed as the physical ability and strength of the operator increases.

### SUMMARY

While prior approaches that produce customized instruction programs based on an operator's prior exercise performance have been successful in many contexts, these approaches many not be suitable for other contexts, especially where there exist cost considerations borne by a gym operator, which costs prohibit providing infrastructure support of attendant systems that often accompany such customized instruction programs.

According to an aspect a computer implemented method for configuring an exercise machine to operate according to a predefined workout regimen, with the exercise machine including exercise apparatus portion that is controlled and configured at least in part by a computing system, with the method including generating a menu for selection of a predefined workout regimen from a plurality of predefined workout regimens, receiving by the computing system in the exercise machine an operator selection of a selected predefined workout regimen, and operator data including at least operator gender, operator height and operator age, retrieve parameter data to configure an exercise instruction that is part of the selected workout regimen from a database that stores at least range of motion data and maximum weight data that are data searchable by a gender/height cohort or gender/age cohort, and converting by the computing system the retrieved parameter data into settings data that configure corresponding portions of the exercise apparatus of the exercise machine according to the configured exercise instruction.

According to an addition aspect, an exercise machine includes a computing system including a processor and memory, exercise apparatus that is controlled and configured at least in part by the computer system to operate according to a predefined workout regimen, with the computing system configured to generate a menu for selection of a predefined workout regimen from a plurality of predefined workout regimens, receive an operator selection of a selected predefined workout regimen, and operating data including at least operator gender, operator height and operator age, retrieve parameter data to configure an exercise instruction that is part of the selected workout regimen, with the parameter data being retrieved from a database that stores at least range of motion data and maximum weight data that are data searchable by a gender/height cohort or gender/age cohort, and provide settings data from the retrieved parameter data, with the settings data configuring corresponding portions of the exercise apparatus of the exercise machine according to the configured exercise instruction.

According to an addition aspect, an exercise machine includes a computing system including a processor and memory, exercise apparatus that is configured at least in part by the computer system to operate according to a predefined workout regimen, with the computing system configured to receive selection of a predefined workout regimen from a plurality of predefined workout regimens, receive operator data including at least operator gender, operator height and operator age, retrieve parameter data to configure an exercise instruction that is part of the selected workout regimen, with the parameter data being retrieved from a database that stores at least range of motion data and maximum weight data that are data searchable by a gender/height cohort or gender/age cohort.

Other aspects include computing systems and computer program products tangible stored on non-transitory computer readable media.

One or more of the following advantages may be provided by one or more aspects of the invention.

The aspects determine pseudo customized exercise plans that are suitable for an operator without the need for the operator to provide any personal information other that age, height, gender, and weight. These techniques enable the operator to select a workout and the aspects dynamically adapt the workout to the operator based solely on the operator's entered personal information. The aspects provide suitable instruction exercise programs for exercise equipment such as strength machines and cardio machines. An operator can select a workout and the system sends a pseudo, customized instruction strength exercise programs to the strength machine to operate the strength machine or sends a pseudo, customized instruction cardio exercise programs to the cardio machine to operate the cardio machine.

The instruction exercise programs, whether customized instruction strength exercise programs for strength machine or pseudo customized instruction cardio exercise programs for cardio machines guide the operator via on-screen instructions that appear on display devices associated with the strength and cardio machines. These approaches provided an effective approach that focuses on properly configuring the exercise machine for an operator's body, by providing a detailed strength and cardio exercise plan that are effectively customized for the operator without the need for testing the operator and requiring the operator to maintain a next workout either by use of a portable storage device or by sharing these data with an entity that stores these data in networked storage.

The details of one or more embodiments of the invention are set forth in the accompanying drawings and the description below. Other features, objects, and advantages of the invention will be apparent from the description and drawings, and from the claims.

### DESCRIPTION OF DRAWINGS

FIGS. 1A and 1B are diagram of strength exercise machine.

FIGS. 1C and 1D are diagrams of interface devices.

FIG. 2 is a diagram of a cardio exercise machine.

FIG. 3 is a high level flow diagram useful in understanding operation of the systems of FIGS. 1A, B and 2.

FIG. 4 is a block diagram of a computing system including in the systems of FIGS. 1A, B and 2.

FIGS. 5-7 are flow diagrams.

FIG. 5A is a block diagram of a database arrangement.

### DETAILED DESCRIPTION

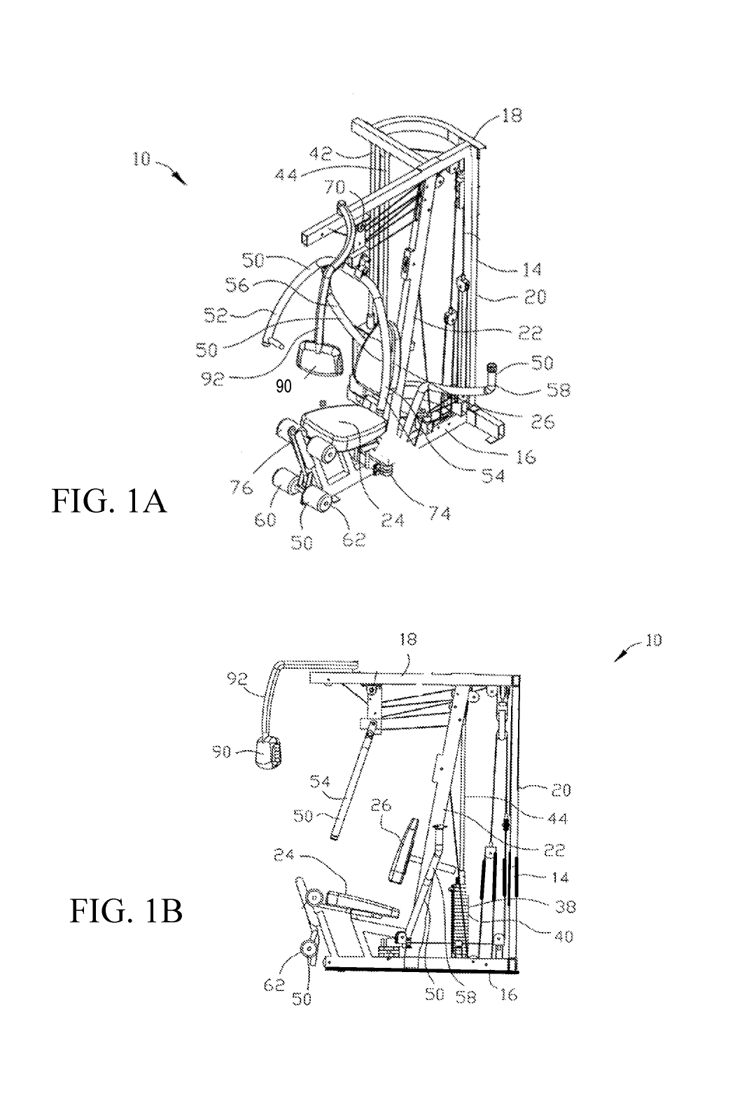

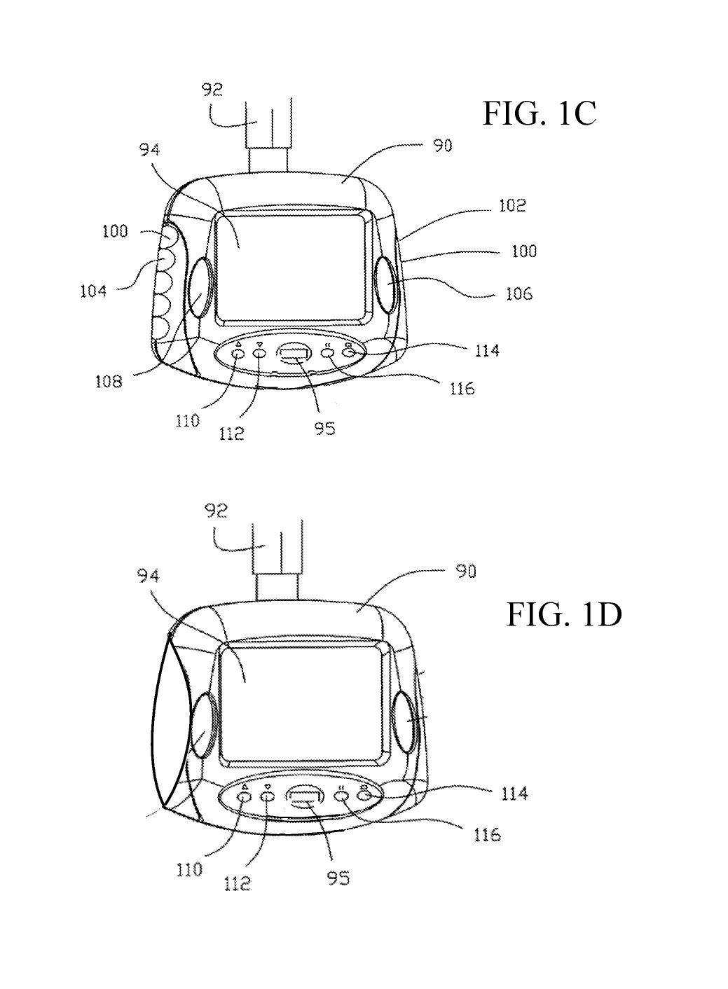

Referring now to FIGS. 1A and 1B, computerized, stand-alone and/or networked exercised systems including exercise machines are shown. FIGS. 1A and 1B show an exemplary strength training machine 10 similar to that described in U.S. Pat. Nos. 7,771,319 and 8,105,207, and which are incorporated herein by reference in their entirety, but modified as will be discussed below.

Other versions of strength machines besides those described in the foregoing US patents could be used. Minimum requirements for such other versions of strength machines are that the other versions: have a mechanism to collect basic operator information such as, personal characteristics data, e.g., physical characteristics such as the operator's age, height, gender and in some instances weight; access to a database that stores data calculated for different combinations (cohorts) of age, height, gender and in some instances weight, which are derived from prior history of workouts, which data can be used to properly configure the strength machine, if needed, and instruct the operator during performance of exercise on the strength machine.

The strength training machine 10 includes a frame 14 that includes a lower frame unit 16 and an upper frame unit 18 that are separated and supported by a first frame coupling 20 and a second frame coupling 22. The frame 14 may be constructed from square tubing apprising steel or other similar material. The lower frame unit 16 supports a seat 24 for supporting a lower portion of an operator. The second frame coupling 22 includes a back rest 26 for supporting an upper portion of the operator. The strength training machine 10 also includes a central frame shroud (not shown) for concealing the first and second frame coupling 20 and 22. The upper frame unit 18 may include an upper frame shroud (not shown) for concealing the upper frame unit 18. The central shroud and the upper frame shroud may be constructed of a polymeric material or other similar material.

The strength training machine 10 also includes a press 50 positioned on the frame 14 for displacement by the operator. The press 50 may include a first and second chest press 52 and 54 for exercising the chest muscles of the operator, first and second back press 56 and 58 for exercising the back muscles of the operator and first and second leg press 60 and 62 for exercising the leg muscles of the operator. It should be understood that other presses may be included in the strength training machine 10.

The strength training machine 10 also includes a module 90 secured to the upper frame unit 18 of the frame 14 by a support arm 92. The module 90 includes a liquid crystal touch screen display (not referenced) for presenting visual data and inputting data. In some implementations, the module 90 includes an input port (not shown), e.g., a USB port, for receiving a memory storage (not shown) for storing data. The module 90 also includes a contact (not shown) for measuring a heart rate and a body fat of the operator. The module 90 may include speakers (not shown) for providing audio instructions or confirmation of an input into the module 90. The module 90 also includes function buttons. The module 90 is part of a computing device 104 that controls the strength training machine 10 and furnishes operator (user) instruction programs, as will be described below.

A load 38 (FIG. 1B) is positioned on the frame 14. Weight guides 42 and 44 extending from the lower frame unit 16 to the upper frame unit 18. The load 38 provides a resistive force to resists a force exerted by the operator. The load 38 has a plurality of weights 40. A particular weight is indicated by the computing system in the machine 10 activating an indicator light (not referenced) on the load mechanism 38. Further details not described here are described in the above incorporated by reference patent.

As shown in FIG. 1C, the strength training machine 10 includes the display 94. The display 94 is included in the user interface module 90 that is secured to the upper frame unit 18 of the frame 14 by the support arm 92 (see FIGS. 1A and 1B). The display is a liquid crystal touch screen display 94 for presenting visual data and inputting data. Other display technologies could be used.

In some implementations, the user interface module 90 can optionally include an input port 95 for receiving a memory storage device (not shown) for storing data and can optionally include a contact 100 for measuring a heart rate and a body fat of the operator, with the contact 100 including a first and a second pad 102 and 104 positioned on either side of the user interface module 90.

The user interface module 90 may further include a first and second speaker 106 and 108 creating audible signals to provide instructions or confirmation of an input into the user interface module 90. The speakers could be replaced or supplemented with an earphone jack, not shown. The user interface module 90 also includes a first and second function button 110 and 112 for increasing or decreasing a function. In addition, the user interface module 90 may include a stop button 114 and a pause button 116 for either terminating the exercising instruction or pausing the exercising instruction.

As shown in FIG. 1D, in other implementations, the user interface module 90 specifically avoids use of an input port 95 for receiving a memory storage device that stores user performance data, etc. and also avoids use of the contact for measuring a heart rate and a body fat of the operator. That is the module 90 can consist essentially of the display 94, speakers 106 and 108 and the buttons 110, 112, 114 and 116 that allow user input to the machine and the port 95 for receiving a user device to play music. The speakers could be replaced or supplemented with an earphone jack, not shown.

In the above mentioned patents the memory storage device in some instances was used to store user performance data that was used by the system to modified exercise instructions in an instruction program during operation of the machine. The contact 100 was used to measure the heart rate of the operator, measure body fat of the operator, etc. for use in establishing a customized program of exercise instructions for the particular operator. This program (with or without modifications) would be stored, e.g., on the memory storage device and a server (not shown).

In the system discussed herein the system needs to collect basic information, personal characteristics data, from the operator, which is physical characteristics of the operator. Examples of such data are, the operator's age, height, gender and in some instances weight. Thus the display can render questions such as “What is your age?” The operator answers to these questions via a graphical user interface (GUI) by actuating buttons or by speaking answers to the questions into a microphone (not shown). Other techniques can be used. The operator may have the option of changing the personal characteristics data if needed. The module 90 includes a computing device that controls the display, controls aspects of the strength training machine 10 and executes an exercise instruction program, as will be described.

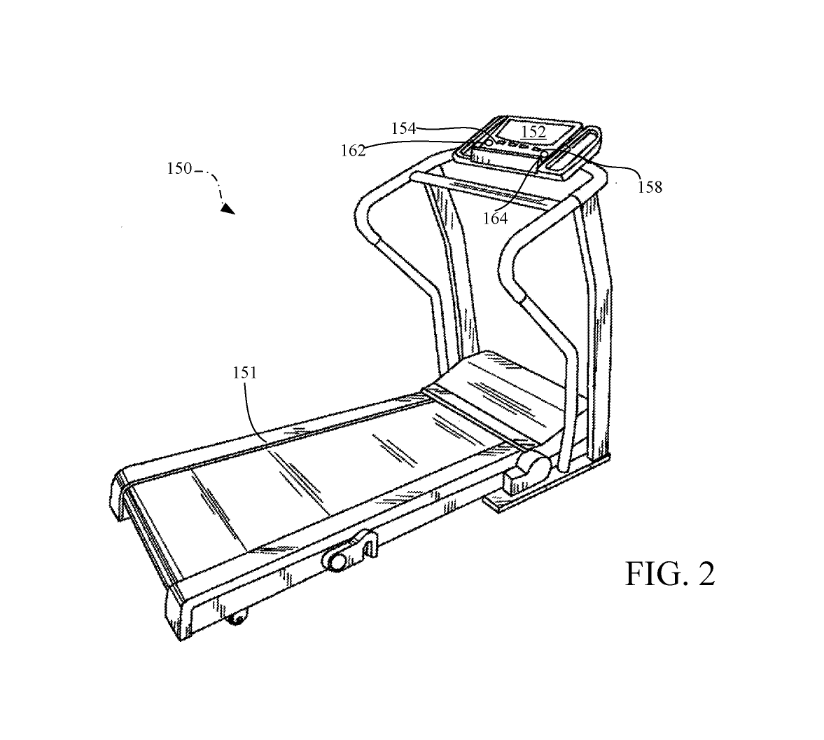

Referring now to FIG. 2, a system 150 including an exemplary cardio exercise machine 151 similar to that described in U.S. Pat. Nos. 8,167,776, 9,050,487 and 9,440,113, and which patents are incorporated herein by reference in their entirety, but modified as will be discussed below. Other cardio machines besides those described in the foregoing US patents could be used. While the cardio exercise machine 151 depicted in FIG. 2 is a treadmill, the techniques described below could be implemented in many different types of cardio exercise machines such as stationary bicycles, recumbent stationary bicycles, stair-climbers, elliptical trainers, ski-trainers, rowing machines, step mills, versa climbers, arc trainers, or hand ergometers. A cardio-machine is typically characterized by an exercise that involves significant cardiovascular exertion in contrast to strength machines that are typically involved with weight training. Cardio exercise machine 151 enables an operator (not shown) to exercise by operating the cardio exercise machine (e.g., by running on the treadmill).

Other versions of cardio machines besides those described in the foregoing US patents could be used. Minimum requirements for such other versions of cardio machines are that the other versions: have a mechanism to collect basic operator information such as, personal characteristics data, e.g., physical characteristics such as the operator's age, height, gender and in some instances weight; access to a database that stores data calculated for different combinations (cohorts) of age, height, gender and in some instances weight, which are derived from prior history of workouts, which data can be used to properly configure the cardio machine, if needed, and instruct the operator during performance of exercise on the cardio machine.

Similar to the strength training machine, the cardio exercise machine 151 includes display 152 that displays questions (e.g., “What is your age?”). The system 150 presents these questions to the operator and collects information such as the operator's age, height, gender and in some instances weight via a graphical user interface (GUI) by actuating buttons 158 on the cardio exercise machine or by speaking answers to the questions into a microphone (not shown). Other techniques can be used. The operator may have the option of changing the personal characteristics data if needed. An operator may connect an existing personal audio device (e.g. an iPod®, an MP3 player, a CD player, etc.) into a line-in jack 112 on a processor board, connect user-wearable headphones into a line out jack 114 on the processor board. A network (not shown) can be used to optionally connect the system 150 to a remote server (not shown). The display 152 is part of a computing device 154 that controls the treadmill and executes an operator instruction program, as will now be described.

The exercise systems 10 or 150 execute pseudo customized workout programs that are based on operator-selected workouts, and operator-entered data, but which are effectively customized without measuring any operator exercise performance, unlike the techniques disclosed in the above applications.

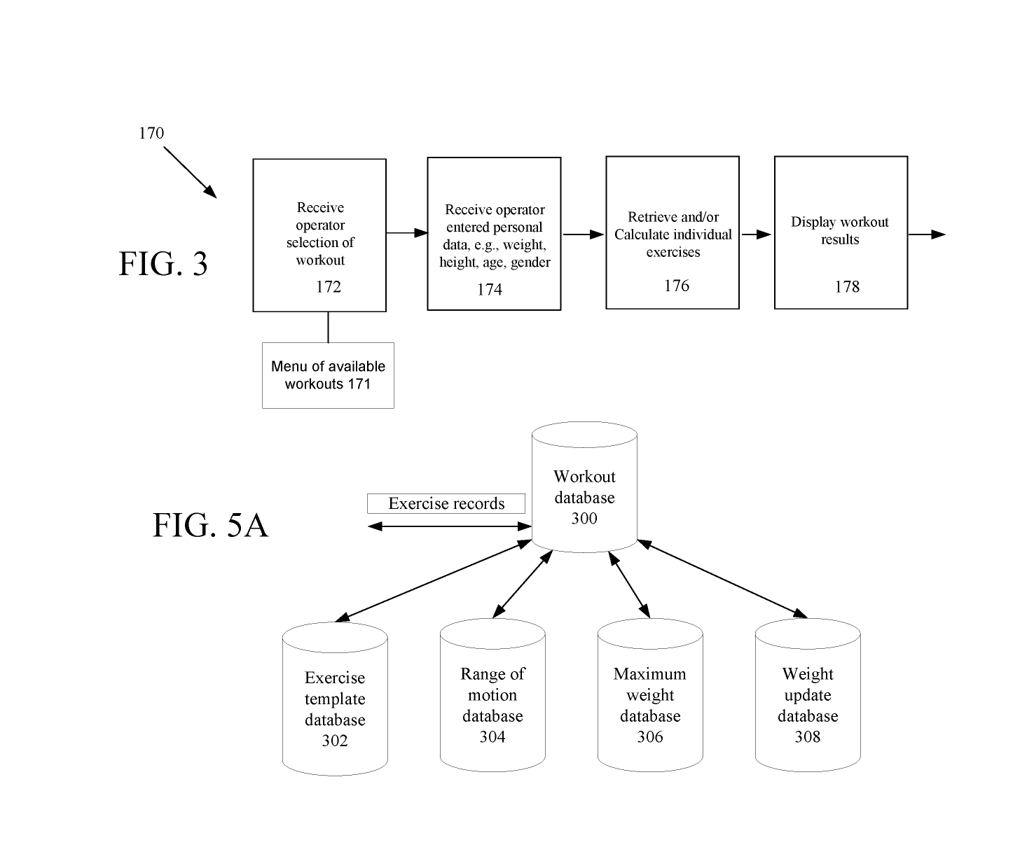

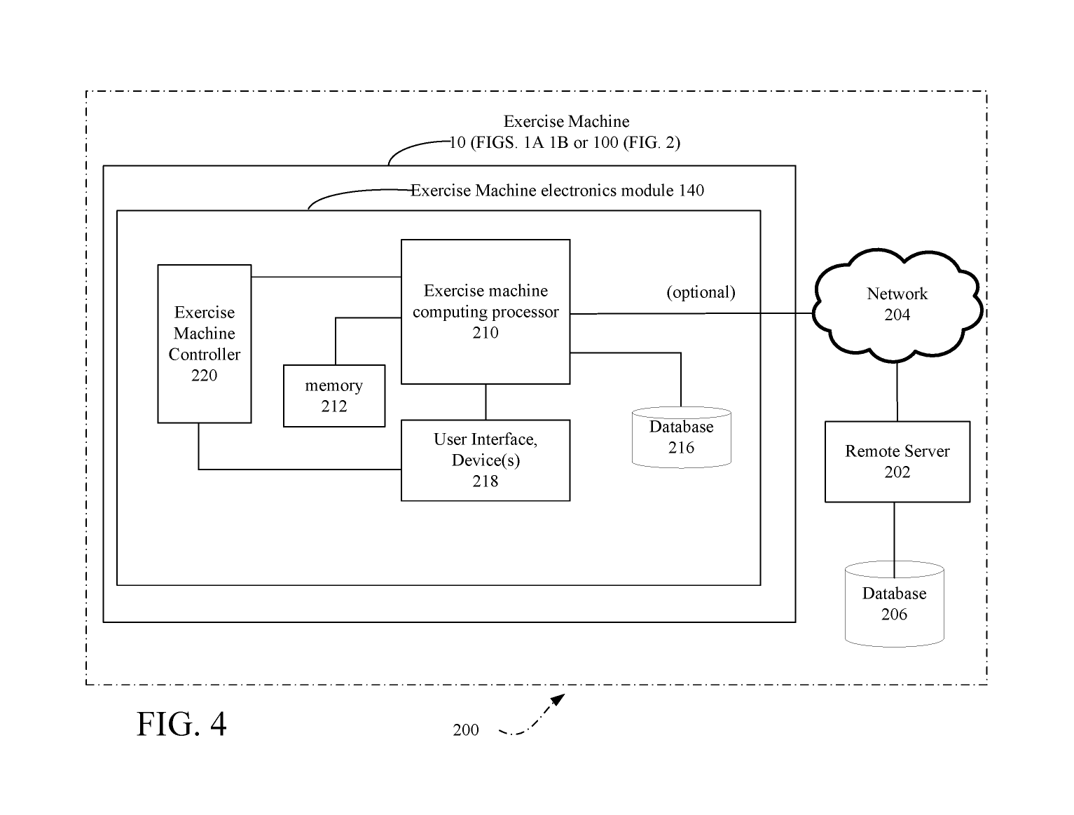

Referring now to FIG. 3, using a database (described below), operation 170 of either the strength training machine 10 or the cardio training machine 150 would proceed generally as follows. Initially, the operator selects a machine, e.g., a strength training machine (such as 10) or a cardio machine (such as 150). The selected machine (e.g., a strength training machine or a cardio training machine) receives 172 an operator selection of a selected workout regimen. The operator (whether a new user to the equipment or an existing user) operator selects the workout from an onscreen menu 171 or from a list of workouts provided audibly to the operator from the exercise system.

By “workout regimen (workout)” is meant a set of exercise instructions to accomplish a specific exercise purpose. The exercise instructions require the operator to perform specific exercises, and are not to be confused with machine program instructions that are instruction code executed by a computing device in the machine. Execution of machine instruction code, i.e., software/firmware produce display messages, etc. and/or configure the machine so that the operator can carry out the exercise instructions by working on the exercise machine.

The operator enters personal characteristics data. This personal characteristics data can be entered either manually, via the interface, orally via talking to the interface (provided speech recognition is available) or electronically via the machine reading a file containing that data from either a storage device or over a network (not shown). In the discussion below the data is entered manually, via a series of menu screens on the user interface 90. The strength training machine 10 or the cardio training machine 150 receives 174 the operator entered personal characteristics data, e.g., height, age, and gender and in some examples weight, and based on that data, the strength training machine 10 or the cardio training machine 150 retrieves from the server or calculates 176 individual exercises based on the operator-entered personal characteristics data, e.g., weight, height, age, and gender. The strength training machine 10 or the cardio training machine 150 displays or renders 178 operator performance during exercise as workout results data.

Upon selection of the workout and the entry of operator data a computing system either local to the machine or remotely connected to the machine calculates settings for each of a group of individual exercises for that operator for the selected workout. The machine applies the calculated settings to either strength training machine 10 or treadmill 150, either by modifying operation of the strength training machine 10 or treadmill 150 or by instructing the user to perform certain actions that modify the operation of the strength training machine 10 or treadmill 150. During operation the computer causes the strength training machine 10 or treadmill 150 to render workout results on the display.

At a high level, the exercise systems 10 or 150 use computer implemented techniques to configure the exercise machine 10 or 150 to operate according to a predefined workout regimen selected by the operator. In aspects, the exercise machine 10 or 150 includes an exercise apparatus portion that is controlled and configured at least in part by the computing system that is typically local to the exercise portion, i.e., within the exercise machine 10 or 150 or in some instances can be remote from exercise machine 10 or 150, e.g., a remote networked server (not shown).

The techniques generate a menu for selection of a predefined workout regimen from a plurality of predefined workout regimens and receive by the computing system an operator selection of a selected predefined workout regimen, and operating data including at least operator gender, operator height and operator age. The computing system retrieves parameter data to configure an exercise instruction that is part of the selected workout regimen, with the parameter data being retrieved from a database that stores at least range of motion data and maximum weight data that are data searchable by a gender/height cohort or gender/age cohort. The computing system converts the retrieved parameter data into settings data that configure corresponding portions of the exercise apparatus of the exercise machine according to the configured exercise instruction.

More specifically, a system accesses a database that stores many operator sessions from many previous workout sessions of many different operators. This data can include hundreds, thousands, tens of thousands, hundreds of thousands, etc. sessions from a large plurality of operators. The database can track this information in a number of ways. One technique simply provides a database record for an operator-workout session pairing and would provide a record such as:

| | | | | | Machine | | | | |
|---|---|---|---|---|---|---|---|---|---|
| Operator | | Operator | | | Machine | Performance | | | |
| ID | Date | characteristics | | | settings | criteria | | | workout |
| | | c-1 | *** | c_n | | p_1 | *** | p_n | Routine |
| | | | | | | | | | no. |

This record stores an ID of a particular operator, date (and time) of a workout, the particular operator's physical characteristics, (e.g., weight, age, gender and height) the machine and machine settings, performance criteria (machine dependent) and the workout selected. Other data could be captured.

Still referring to FIG. 3, using the database record as set out above, operation of either the strength training machine 10 or the cardio machine 150 is based on the operator selected “workout,” (i.e., workout regimen) as discussed.

Consider the strength training machine 10 of FIGS. 1A-1D. The strength training machine 10 discussed above, is extremely versatile, meaning that the strength training machine 10 can be used to exercise many parts of an operator's body, e.g., leg, arm, and chest muscles, as well as many other muscles, simply by adjusting the operator's position on the machine 10 and using different ones of the presses 50 and configuring the machine appropriately with specific settings. A similar concept of workout exists with a cardio machine such as treadmill 150. For example, a workout for the treadmill 150 could be sprint type (fast short time) or a dawdle (slow, long time) workout.

However, for each workout and each type of equipment, there needs to be a configuration of the particular machine, e.g., strength training machine 10 or treadmill 150 for the selected workout. The configuration needs to be suitable for the operator, and yet needs to be supportive of increasing difficulty, over time, so that the operator will advance through more difficult versions of a given workout regimen, which will require changing settings for the equipment. Therefore, the configuration of the machine needs to change by a system learning process that learns when these settings should be changed as the physical ability and strength of the operator increases.

Referring now to FIG. 4, a system 200 for calculating and determining individual exercises for a selected regime is provided by either a remote server 202 via a network 204 using a networked database 206 or is provided by a computing system that is part of the strength training machine 10 or the cardio training machine 150 in communication with a remote database 206. In this latter example, the strength training machine 10 or the cardio training machine 150 retrieves machine settings data and perform the calculations locally based on personal information entered by the operator.

The strength training machine 10 or the cardio training machine 150 includes a processor 210 that executes algorithms using computer instructions in main memory 212 using data obtained from the local database 216, as shown. This local database 216 contains data the same as or derived from database 206. In some implementations, a machine controller 220 that controls aspects of the strength training machine 10 or the cardio training machine 150 receives settings data from the processor 210 to control operation of the machine (each including interfaces, etc. not shown). In other implementations, the operation of the machine is provided from the processor 210 obviating the need for a separate machine controller. A user interface 218 (e.g., aspect of module 90 or 152) receives the operator input and feeds the operator input to the processor 210.

To perform remote calculations, the machine 10 or 150 would require sufficient computing resources such that operator input is sent to the remote computing system, e.g., server 202 via the network 204 and the 202 server would perform the calculations and send settings data and other information back to the processor 210 or the machine controller 220 to control operation of the machine 10 or 150.

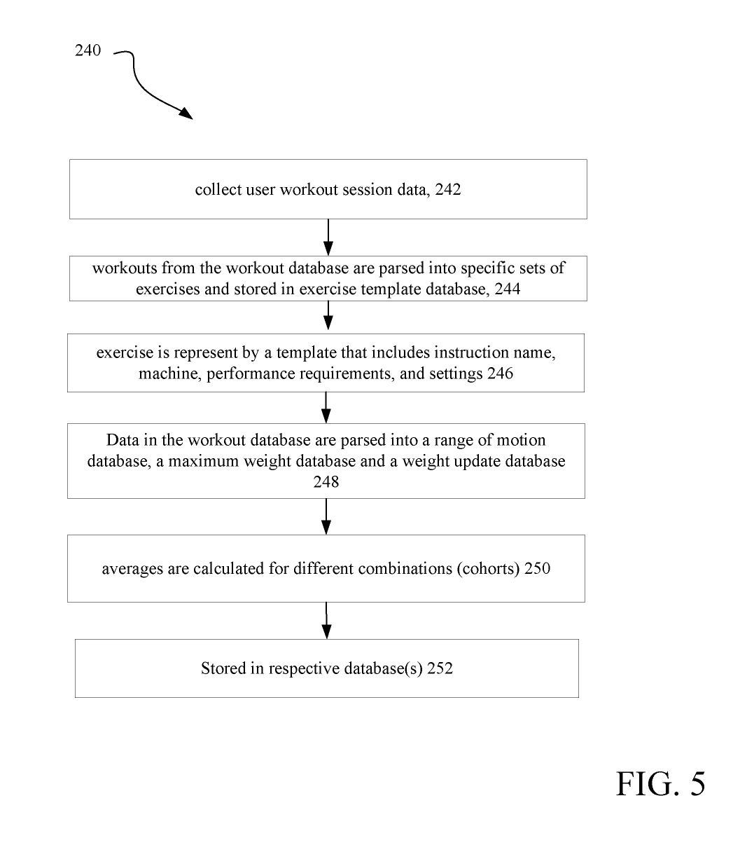

Referring now to FIGS. 5 and 5A, the pseudo-customized workouts described herein are generally applicable to either strength training machines (such as strength training machine 10 of FIGS. 1A-1D) or cardio machines, such as cardio training machine 150 (FIG. 2).

Referring to FIG. 5, a collection/parsing process 240 is shown. The collection/parsing process of operator data over many different workouts, types of operators (gender, age, height, weight) to build an cohort repository database of collected operator workout session data. The process collects 242 workout session data and operator-entered personal characteristics data, e.g., weight, height, age, and gender from many operators (e.g., hundreds, thousands, tens of thousands, etc. of operators) over many sessions (e.g., hundreds, thousands, tens of thousands, etc.) or at least a sufficient number of operators over a sufficient number of sessions to have a statistically suitable sample of a broad cross-section of many different types of operators on different types of equipment and workouts. These data are collected in a workout database (see FIG. 5A) from records as in Table 1 above.

During collection of personal workout session data and operator-entered personal characteristics data, e.g., weight, height, age, and gender, personally identifiable data, e.g., name, address, etc., may be collected as well or may be present in some prior collections of data. However, personally identifiable data need not be used for the systems discussed herein and therefore should be considered as distinct from personal workout session data and operator entered personal characteristics data.

The workouts from the workout database are parsed 244 into specific sets of exercises and stored in exercise template database. That is, each exercise is represent 246 by a template, (i.e., exercise instruction template) in a set of exercises (i.e., workout), which template includes an instruction name concatenated with values of the machine, performance requirements, and settings for the particular machine. For example, for a workout that includes an exercise instruction involving repetitions using the first and second chest press 52 and 54, an instruction template could be:

| | | | Parameter 1 | | Parameter n |
|---|---|---|---|---|---|
| Name | Machine | requirements | weight | *** | Rate |
| Chest press A | Strength | <Number of | Enable load | *** | <Number of |
| | trainer | reps> per | indicator X | | reps/minute> |
| | model A | time period | | | |

The template would have the template name “Chest press A”, on a machine (machine type, model), the number of repetitions (a performance requirement), and one of more parameters, i.e., settings on the machine, such as a setting that selects the weight to set on the load device 38 and a setting that causes a display to render a message that tells the operator to stop or as shown a setting that causes the display to render a performance criteria for that exercise instruction. For the machine 10 in FIGS. 1A, 1B the weight parameter could include settings that will active an indicator light (as more fully disclosed in the patents) to aid in selection of a weight to place on the load 38. Templates are provided for each of the exercises that can be performed on the exercise machine 10. The template will all have an exercise name and machine type, fields for performance requirement(s) and fields for parameters that are translated into settings for the controller 220 or the processor 210.

The data in the workout database are further parsed 248 into a range of motion database, a maximum weight database and a weight update database. Machine learning algorithms at a high end of sophistication to relative simple algorithms to calculate averages can be used for this parsing. These data are calculated 250 for different combinations (cohorts) of age, height, gender and in some instances weight. These are stored 252 in the respective database(s) and are searchable by the cohort (gender/height) or (gender/age) that returns a value.

Referring now also to FIG. 5A, the workout database 300 is shown. In this instance, the workout database includes data (personal characteristics data and operator performance data) collected from many operator sessions from many previous workout sessions of many different operators. These data can include hundreds, thousands, tens of thousands, hundreds of thousands, etc. sessions from a large plurality of operators, as discussed above. The workout database 300 thus contains raw data records that are parsed to provide data for specific databases, e.g., range of motion database 304, weight database 306 and weight update database 308. Retrieved data from these databases will be used to populate templates retrieved from an exercise template database 320. These databases can be separate databases or partitions of a common database or a single database in which the appropriate data are provided according to a specific query.

For instance, in the range of motion database 304 are stored determined average range of motion data for plural gender/height cohorts.

Exemplary cohorts would be

| | Height | Height | | Height |
|---|---|---|---|---|
| Gender | range 1 | range 2 | *** | range n |
| F | R_H1F | R_H2F | *** | R_HnF |
| M | R_H1M | R_H2M | *** | R_HnM |

where for value “R_H1M”, “R_H1” is range of motion determined value for a first cohort Height range 1 and “M” is the gender value male. In some implementations, other cohorts could be unspecified gender or a transgender, etc. In the range of recommended weight database 306 are stored determined average weight loading data for plural gender/age cohorts. In some implementations, other cohorts could be unspecified gender or a transgender, etc.

Exemplary cohorts would be

| | age | age | | Age |
|---|---|---|---|---|
| Gender | range 1 | range 2 | *** | range n |
| F | W_A1F | W_A2F | *** | W_AnF |
| M | W_A1M | W_A2M | *** | W_AnM |

where for value “W_A1F”, “W_A1” is determined recommended weight value for a first cohort Age range 1 and “F” is the gender value female.

Each of R_H1F to R_HnM and W_A1F to W_AnM are parameter values that are either used directly or are translated into settings for each machine. Thus once knowing a person's gender, age and height, the computer calculates values of the settings for the machine for each particular exercise, as derived from the selected workout and which calculated values are used to populate a specific template retrieved from the exercise template database 302.

Cohorts can also take into consideration an operator's weight. For instance, in the range of recommended weight database 306 could be stored determined average weight loading data for plural gender/age/weight cohorts. In some implementations, other cohorts could be unspecified gender or a transgender, etc.

Exemplary cohorts would be

| | age range 1 | | | age range 2 | | | | Age range n | | |
|---|---|---|---|---|---|---|---|---|---|---|
| Gender | w1 | w2 | w3 | w1 | w2 | w3 | *** | w1 | w2 | w3 |

| | | | | |
|---|---|---|---|---|
| F | W_A1F₁-W_A1F₃ | *** | *** | W_AnF₁-W_AnF₃ |
| M | W_A1M₁ W_A1M₃ | *** | *** | W_AnM₁-W_AnM₃ |

where for values “W_A1F to W_A1F₃” these are determined recommended weight value for a first cohort Age range 1 and “F” is the gender value female over three defined weight ranges.

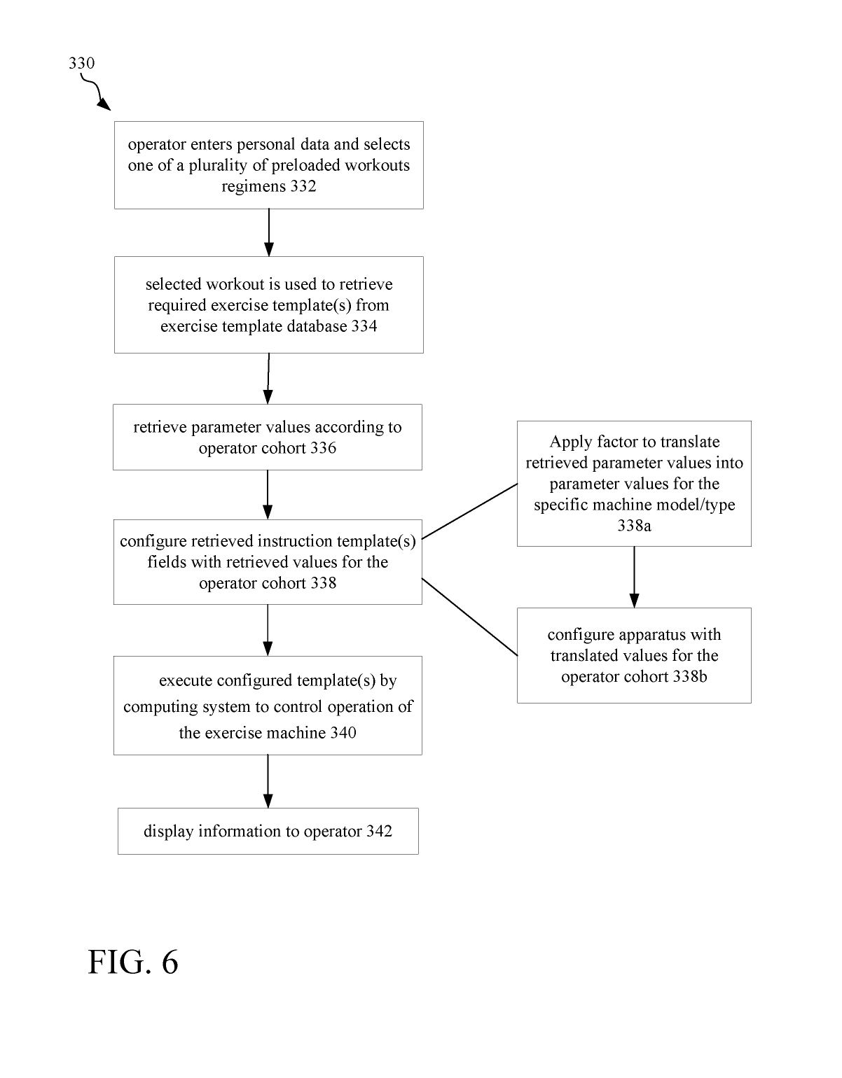

Referring now to FIG. 6, in operation 330 of a machine 10 or 100 (or other types) the operator enters 332 his/her data, and one of the preloaded workouts. The selected workout is used by the computing system to retrieve 334 required exercise instruction(s) by sending a query to retrieve each of the exercise instruction templates(s) from the database according to the selected workout. The operator data (age, gender, height) are used to retrieve 336 parameter values according to the operator cohort defined by the operator data (age, gender, height). These retrieved values are used by the computing system to configure 338 each of the retrieved instruction template(s) fields by populating the fields with corresponding retrieved values for the operator cohort. The configured template(s) are executed 340 by the computing system to control operation of the exercise machine and display 342 of information to the operator.

In some implementations it may be necessary to translate values 338a to configure template(s) into a specific set or sets of settings that are used to configure 338b the exercise apparatus. In other implementations, it may be necessary to translate values in the configured template(s) into a specific set or sets of settings that are used to configure the exercise apparatus.

In the implementations similar to the machine 10 or 100, the values retrieved can be used directly as settings to configure the exercise apparatus. For example, consider that the recommended weight database has stored determined average weight loading data for plural gender/age cohorts. In the implementation using the strength training machine 10 (FIGS. 1A, 1B) the load 38 has indicator lights (see incorporated by reference patents) that are used to indicate where a pin should be inserted so as to select the proper weight element. In this instance, the data in the template could be a setting value that is directly used by the computer to light the proper indicator light. This setting value will be used to configure a set of computer instructions that when executed by the processor 210 causes the appropriate indicator light on the load 38 to light.

Consider a different type of exercise machine that uses a different mechanism to provide the proper loading. Consider again the range of recommended weight database, the database can store determined average weight loading data values for plural gender/age cohorts. The correct weight value can be passed to computing device that translates the retrieved weight loading data into the proper settings on that exercise machine, according to specific requirements of that machine.

Thus, the exercise system 10 or 150 includes a set of “pre-loaded” exercise sessions or workouts that are selectable by the operator. These pre-loaded sessions or workouts are comprised of one or several exercise templates that are personalized to each operator's perceived level of fitness using a number of factors that are derived from the database, without the need for any on-machine testing protocols or other factors commonly used in fully customized exercise systems, as described above.

The personalized options relating to the workout (e.g., the intensity of the workout, the type of workout, etc.) are configured locally by the exercise machine from the databases depicted in FIG. 5A. Thus, in addition to the exercise system 10 or 150 including a set of “pre-loaded” selectable exercise sessions or workouts, each of these selectable exercise sessions or workouts can further include plural intensity levels of a predetermined number of levels. For example, workouts can be low, moderate medium and advanced and which are selected by the operator as part of workout selection. The intensity level is used as another search value to obtain the proper settings for the machine 10 or 100 (or other machine types) based on the determined operator cohort and the selected intensity sub cohort for the particular operator.

With this implementation, the databases of FIG. 5A can be configured either to store plural parameter values for each cohort, the correct one be used based on the operator's intensity selection or different databases could be used for each intensity level. These techniques give the operator the ability to choose what type of workout they want to do and the intensity level (low, moderate, medium, advanced, etc.) each time they workout. This arrangement is in contrast to the exercise machine pre-determining for the operator what the workout will be and the intensity level based on a pre-determined plan derived from prior sessions.

The machine provides exercise guidance and instruction via a combination of on-machine messaging, automatic machine control of speed, incline, intensity, etc. via the CSAFE protocol or other proprietary protocols, and audio-based coaching and content.

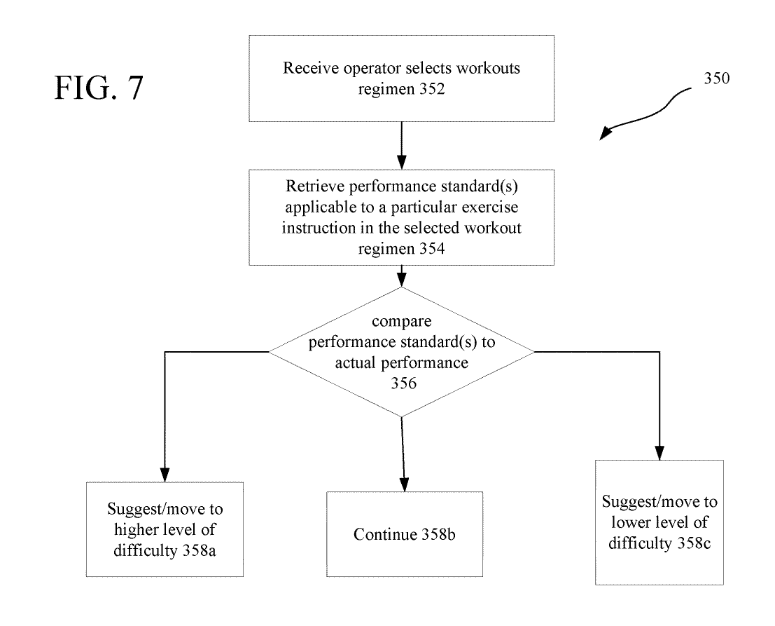

Referring now to FIG. 7, in some implementations 350, the machine (of either machine type 10 or machine type 100) measures an operator's performance during a session and adjusts the values or recommends adjustment of the values of settings for the machine during the session. The machine 10 or 100 has the customized workout 352. With the customized workout is a set of standard(s), e.g., a range within which the operator should be able to perform each particular exercise. The machine 10 or 100 either has these or retrieves these performance standard(s) applicable to a particular exercise instruction in the selected workout regimen 354, and monitors 356 the operators performance by comparing the operator's performance against the set of standard(s) for a given exercise. When the performance is above the standard 358a the machine will calculate new settings for the machine that moves the level of difficulty to a higher level (and conversely to a lower level when the performance is below the standard 358c). Otherwise if the calculated performance is within the range, no changes are made and the process continues 358b. Changes are either applied during the operation of the machine or made as a suggestion to the operator. One general way to adjust the recommended values is for example by suggesting that the operator increase an intensity level or decrease an intensity level depending on the operator's performance.

More specifically, the machine calculates adjustments for the recommended values of the exercise and configures the exercise machine with adjusted settings. The adjusted values are based on corresponding parameters for the particular exercise being performed (and/or the user's overall exercise plans). The parameter values used to determine the recommended values are retrieved from the database according to the user's cohort. The machine converts these retrieved parameter values into settings to adjust operation of the machine. If the user inputs to the machine (e.g. user's weight, repetitions of an exercise completed by the user, and the range of motion used by the user) do not match (or do not match within a defined tolerance) the parameter values provided, the machine will re-run the calculation using the actual parameter values inputted by the user, and use those parameter values to calculate new settings for the machine and use these parameter values for future calculations rather the parameter values from the database. At the end of the session the operator's performance data is displayed on the screen.

However, the current session data is not saved on an operator device or specifically associated with the operator. A new session, for the same operator will again start off as before by the operator entering the personal characteristics data and the machine applying calculated settings based on the entered personal characteristics data.

The server 12 executes the algorithm that produces results that are sent to the databases and that are loaded on machines, e.g., the strength machine 10. The system provides these pseudo customized exercise plans based on each operator's inputted age, gender, and height data (and in some instances weight) without the need to measure the operator's exercise activity. With this information, the system produces pseudo customized exercise instructions that can be complied into workout programs integrated together automatically to form a dynamically changing/adapting integrated methodology. Workouts can be expressed in various ways. One way is by goals. Goals include Build muscle, Burn fat, Protect metabolism, various health conditions, etc.

Server can be any of a variety of computing devices capable of receiving information, such as a server, a distributed computing system, a desktop computer, a laptop, a cell phone, a rack-mounted server, and so forth. Server may be a single server or a group of servers that are at a same location or at different locations. Server can receive information from user device, including, e.g., graphical user interfaces. Interfaces can be any type of interface capable of receiving information over a network, such as an Ethernet interface, a wireless networking interface, a fiber-optic networking interface, a modem, and so forth. Server also includes a processor and memory. A bus system (not referenced) can be used to establish and to control data communication.

Processor may include one or more microprocessors. Generally, processor may include any appropriate processor and/or logic that is capable of receiving and storing data, and of communicating over a network (not shown). Computer readable and/or machine-readable hardware storage device include memory. Memory can include a hard drive and a random access memory storage device, such as a dynamic random access memory, machine-readable media, or other types of non-transitory machine-readable storage devices. Components also include storage device, which is configured to store information collected through the brokerage system during a physician's consultation with a patient, as well as an operating system and application software.

Embodiments can be implemented in digital electronic circuitry, or in computer hardware, firmware, software, or in combinations thereof. Apparatus of the invention can be implemented in a computer program product tangibly embodied or stored in a computer readable and/or machine-readable hardware storage device for execution by a programmable processor; and method actions can be performed by a programmable processor executing a program of instructions to perform functions and operations of the invention by operating on input data and generating output. The invention can be implemented advantageously in one or more computer programs that are executable on a programmable system including at least one programmable processor coupled to receive data and instructions from, and to transmit data and instructions to, a data storage system, at least one input device, and at least one output device. Each computer program can be implemented in a high-level procedural or object oriented programming language, or in assembly or machine language if desired; and in any case, the language can be a compiled or interpreted language.

Suitable processors include, by way of example, both general and special purpose microprocessors. Generally, a processor will receive instructions and data from a read-only memory and/or a random access memory. Generally, a computer will include one or more computer readable and/or machine-readable hardware storage devices such as mass storage devices for storing data files; such devices include magnetic disks, such as internal hard disks and removable disks; magneto-optical disks; and optical disks. Storage devices suitable for tangibly embodying computer program instructions and data also include all forms of non-volatile memory, including by way of example semiconductor memory devices, such as EPROM, EEPROM, and flash memory devices; magnetic disks such as internal hard disks and removable disks; magneto-optical disks; and CD_ROM disks. Any of the foregoing can be supplemented by, or incorporated in, ASICs (application-specific integrated circuits).

A number of embodiments of the invention have been described. Nevertheless, it will be understood that various modifications may be made without departing from the spirit and scope of the invention. Accordingly, other embodiments are within the scope of the following claims.

What is claimed is:

1. A computer implemented method for configuring an exercise machine to operate according to a predefined workout regimen, with the exercise machine including exercise apparatus portion that is controlled and configured at least in part by a computing system, with the method comprising:
generating a menu for selection of a predefined workout regimen from a plurality of predefined workout regimens;
receiving by a computing system an operator selection of a selected predefined workout regimen, and operating data including at least operator gender, operator height and operator age;
retrieving by the computing system parameter data to configure an exercise instruction that is part of the selected workout regimen, with the parameter data being retrieved from a database that stores at least range of motion data and maximum weight data that are data searchable by a specified cohort; and
providing settings data by the computing system from the retrieved parameter data with the settings data configuring corresponding portions of the exercise apparatus of the exercise machine according to the configured exercise instruction.

2. The method of claim 1 wherein the specified cohort is a gender/height cohort or gender/age cohort and the database is comprised of a range of motion database that stores predetermined average range of motion data for plural gender/height cohorts and a recommended weight database that stores determined average weight loading data for plural gender/age cohorts.

3. The method of claim 2 wherein the range of motion data retrieved from the range of motion database are parameter values that are translated into settings for the exercise machine.

4. The method of claim 2 wherein the recommended weight data retrieved from the recommended weight database are parameter values that are translated into the settings data for the exercise machine.

5. The method of claim 1 wherein the exercise machine is a cardio exercise training machine and the computer is in the cardio exercise training machine.

6. The method of claim 1 wherein the exercise machine is a strength exercise machine and the computer is in the strength training machine.

7. The method of claim 1 wherein the database that stores the range of motion data and the maximum weight data and the computer system are in the exercise machine.

8. The method of claim 1 wherein the database and the computer system are in the exercise machine, and the database is updatable by a remote system.

9. The method of claim 1 wherein the database and the computer system are remote from the exercise machine.

10. The method of claim 1 wherein the computer is a remote computer physically separated from the exercise machine, the method further comprising:
sending by the remote computer to a second computer in the exercise machine the determined settings data for the machine.

11. An exercise machine comprises:
a computing system including a processor and memory;
exercise apparatus that is controlled and configured at least in part by the computer system to operate according to a predefined workout regimen, with the computing system configured to
generate a menu for selection of a predefined workout regimen from a plurality of predefined workout regimens;
receive an operator selection of a selected predefined workout regimen, and operating data including at least operator gender, operator height and operator age;
retrieve parameter data to configure an exercise instruction that is part of the selected workout regimen, with the parameter data being retrieved from a database that stores at least range of motion data and maximum weight data that are data searchable by a gender/height cohort or gender/age cohort; and
provide settings data from the retrieved parameter data, with the settings data configuring corresponding portions of the exercise apparatus of the exercise machine according to the configured exercise instruction.

12. The exercise machine of claim 11 wherein the database is comprised of a range of motion database that stores predetermined average range of motion data for plural gender/height cohorts and a recommended weight database that stores determined average weight loading data for plural gender/age cohorts.

13. The exercise machine of claim 12 wherein the range of motion data retrieved from the range of motion database are parameter values that provide settings for the exercise machine.

14. The exercise machine of claim 12 wherein the recommended weight data retrieved from the recommended weight database are parameter values that are translated into the settings data for the exercise machine.

15. The exercise machine of claim 11 wherein the exercise machine is a cardio exercise training machine.

16. The exercise machine of claim 11 wherein the exercise machine is a strength exercise machine.

17. The exercise machine of claim 11 wherein the database is local to the computing system in the exercise machine.

18. The exercise machine of claim 12 wherein the database is in the exercise machine and is updatable by a remote system.

19. The exercise machine of claim 12 wherein the database is remote from the exercise machine.

20. The exercise machine of claim 11 wherein each exercise in the workout regimen is represented as a template that includes an instruction name, a performance requirement, one or more values for one or more settings for the exercise machine, and the database stores determined average range of motion data for plural gender/height cohorts, and recommended average weight loading data for plural gender/age cohorts with each of parameter values are either used directly or are translated into settings for the machine.

21. The exercise machine of claim 21 wherein the database stores cohorts according to an operator's weight.

22. The exercise machine of claim 11 further configured to:
measure an operator's performance during a session; and
adjust settings for an exercise during the session.

23. The exercise machine of claim 11 further configured to:
measure an operator's performance during a session against a standard; and
adjusts the settings when the performance deviates from a range about the standard.

24. An exercise machine comprises:
a computing system including a processor and memory;
exercise apparatus that is configured at least in part by the computer system to operate according to a predefined workout regimen, with the computing system configured to:
receive selection of a predefined workout regimen from a plurality of predefined workout regimens;
receive operator data including at least operator gender, operator height and operator age;
retrieve parameter data to configure an exercise instruction that is part of the selected workout regimen, with the parameter data being retrieved from a database that stores at least range of motion data and maximum weight data that are data searchable by a gender/height cohort or gender/age cohort.

25. The exercise machine of claim 24 wherein the computing system is further configured to:
provide settings data from the retrieved parameter data, with the settings data configuring corresponding portions of the exercise apparatus of the exercise machine according to the configured exercise instruction.

26. The exercise machine of claim 24 wherein the database is comprised of a range of motion database that stores predetermined average range of motion data for plural gender/height cohorts and a recommended weight database that stores determined average weight loading data for plural gender/age cohorts.

27. The exercise machine of claim 24 wherein the database is local to the machine.

28. The exercise machine of claim 24 wherein the database is remote from the machine, and the machine further includes a network connection to connect the database to the machine.
